(19) United States
(12) Patent Application Publication
(10) Pub. No.: US 2012/0002239 A1
(43) Pub. Date: Jan. 5, 2012

(54) MENU DISPLAY SYSTEM, MENU DISPLAY METHOD, AND SERVER DEVICE

(75) Inventor: Kinko OKAMURA, Matsumoto (JP)

(73) Assignee: SEIKO EPSON CORPORATION, Tokyo (JP)

(21) Appl. No.: 13/174,918

(22) Filed: Jul. 1, 2011

(30) Foreign Application Priority Data
Jul. 1, 2010 (JP) 2010-150834

(51) Int. Cl. G06K 15/02; G06F 3/048

(52) U.S. Cl. 358/1.15; 715/810

(57) ABSTRACT

To generate and display a menu display in a printer so as to be adapted to the user. A server device connected so as to be capable of communication between a printing device and an information terminal device comprises a packet communication part for receiving user information designed to uniquely identify a user who operates a portable terminal; a network communication part for receiving printing-device information designed to uniquely identify a printer; a selectable-service determining part for extracting, based on the printing-device information thus received, services that can be executed by the printer, and determining, based on the user information, a service that can be selected by the user; and a menu-screen information creating part for generating, in a format that can be displayed by the printing device, menu information which includes the service thus determined; and transmits the menu information thus generated to the printer.

### CROSS-REFERENCE TO RELATED APPLICATIONS

This application claims priority to Japanese Patent Application No. 2010-150834 filed on Jul. 1, 2010. The entire disclosure of Japanese Patent Application No. 2010-150834 is hereby incorporated herein by reference.

### BACKGROUND

1. Technological Field

The present invention relates to a menu display system, a menu display method, and a server device.

2. Background Technology

There are printers in which a display panel and an operating button are provided in order to issue printing instructions or set printing settings such as layout settings on the printer. Through the use of the operating button, a user issues an instruction for a desired item from a menu displayed on the display panel, and the function that corresponds to the instruction can thereby be executed.

A multifunction machine has also been provided in which a scanner function or a communication function is added to a printer. For such a printer, a technique has been proposed whereby selection of the desired function can be facilitated by layering the menu so that a wide range of settings such as communication settings and multifunction settings, and instructions for executing services connected to on a network, can be performed in addition to layout settings.

In Patent Citation 1, for example, a printing device is disclosed in which frequency information is collected for indicating the frequency with which an instruction is issued for each item of a layered menu, and the layered levels of the menu are changed based on the collected frequency information. Although such a menu is usually set at the time the printer is shipped, a technique is also known whereby the menu can be updated by connecting to a server of the printer manufacturer or the like via a network even after the printer has been purchased.

Japanese Patent Application Publication No. 9-104151 (Patent Citation 1) is an example of the related art.

### SUMMARY

### Problems to be Solved by the Invention

However, in the menu of the printing device described above, although the layering level of a displayed item changes according to frequency of selection, the number of items that can be selected in the menu does not increase or decrease, and is prescribed by the menu set in the printer. Consequently, items cannot be added to or removed from the menu in accordance with the user of the printer or the environment in which the printer is installed. An object of the invention is to generate and display a printer menu in accordance with a user.

### Means Used to Solve the Above-Mentioned Problems

The invention has been devised in order to solve at least some of the above-mentioned problems, and can be reduced to practice according to embodiments or application examples described below.

### APPLICATION EXAMPLE 1

A menu display system according to a first application example is a menu display system in which a server device, a printing device, and an information terminal device are connected so as to be capable of communication; the menu display system characterized in that the information terminal device has a user-information obtaining part for obtaining user information designed to uniquely identify a user who operates the information terminal device; and a first transmitting part for transmitting the user information thus obtained to the server device; the printing device has a printing-device information obtaining part for obtaining printing-device information designed to uniquely identify the printing device; a second transmitting part for transmitting the printing-device information thus obtained to the server device; a first receiving part for receiving, from the server device, menu information for issuing an instruction to execute a predetermined service; and an information display part for displaying the menu information thus received; and the server device has a second receiving part for receiving the user information transmitted from the information terminal device; a third receiving part for receiving the printing-device information transmitted from the printing device; a selectable-service determining part for extracting, based on the printing-device information thus received, services that can be executed by the printing device, and determining, based on the user information thus received, the service that can be selected by the user from the services thus extracted; a generating part for generating the menu information, which includes the service thus determined; and a third transmitting part for transmitting the menu information thus generated to the printing device.

Through such a configuration, user information designed to uniquely identify the user who operates the information terminal device, and printing-device information designed to uniquely identify the printing device are each obtained and transmitted to the server device. The server device extracts, based on the printing-device information thus received, services that can be executed by the printing device, determines, based on the user information thus received, the service that can be selected by the user from the services thus extracted, generates menu information which includes the service thus determined, and transmits the menu information to the printing device. The printing device receives the menu information thus transmitted and displays the menu information in the information display part. Consequently, a menu that includes the service that can be selected by the user from among the services that correspond to the printing device is displayed in the printing device, and the menu of the printing device can therefore be generated and displayed so as to be adapted to the user.

### APPLICATION EXAMPLE 2

A menu display system according to a second application example is characterized in that the information terminal device has a first positional information obtaining part for obtaining first positional information relating to the position of the information terminal device; and transmits the first positional information thus obtained to the server device; the printing device has a second positional information obtaining part for obtaining second positional information relating to the position of the printing device; and transmits the second positional information thus obtained to the server device; and the server device receives the first positional information transmitted from the information terminal device and the second positional information transmitted from the printing device; and has a judgement part for judging, based on a comparison between the first positional information and the second positional information thus received, whether the printing device is usable or unusable by the user.

Through such a configuration, it is possible to judge, based on the positional information about the user and the printing device, whether the printing device can be used by the user.

### APPLICATION EXAMPLE 3

A menu display system according to a third application example is characterized in that the server device has a fourth transmitting part for transmitting, to the information terminal device, the printing-device information relating to the printing device judged by the judgement part to be usable; the information terminal device has a fourth receiving part for receiving the printing-device information transmitted from the server device; a display part for displaying the printing-device information thus received; and a selecting part for selecting at least one piece of information from the printing-device information thus displayed; and the information terminal device transmits the printing-device information selected by the selecting part to the server device, and the server device determines the service that can be selected for the printing device corresponding to the printing-device information transmitted from the information terminal device.

Through such a configuration, the desired printing device can be selected from printing devices that can be used by the user, and a menu that is adapted to the user can be shown.

### APPLICATION EXAMPLE 4

A menu display method according to a fourth application example is a menu display method comprising connecting a server device, a printing device, and an information terminal device so as to be capable of communication, and displaying a menu on the printing device; the menu displaying method characterized in further comprising the steps of: the printing device obtaining printing-device information designed to uniquely identify the printing device; the printing device transmitting the printing-device information thus obtained to the server device; the server device receiving the printing-device information transmitted from the printing device; the information terminal device obtaining user information designed to uniquely identify a user who operates the information terminal device; the information terminal device transmitting the user information thus obtained to the server device; the server device receiving the user information transmitted from the information terminal device; the server device extracting, based on the printing-device information thus received, services that can be executed by the printing device; the server device determining, based on the user information thus received, the service that can be selected by the user from the services thus extracted; the server device generating menu information that makes it possible to issue an instruction to execute the service thus determined; the server device transmitting the menu information thus generated to the printing device; the printing device receiving, from the server device, the menu information for executing a predetermined service; and the printing device displaying the menu information thus received.

Through such a method, user information designed to uniquely identify the user who operates the information terminal device, and printing-device information designed to uniquely identify the printing device are each obtained and transmitted to the server device. The server device extracts, based on the printing-device information thus received, services that can be executed by the printing device, determines, based on the user information thus received, the service that can be selected by the user from the services thus extracted, generates menu information which includes the service thus determined, and transmits the menu information to the printing device. The printing device receives and displays the menu information thus transmitted. Consequently, a menu that includes the service that can be selected by the user from among the services that correspond to the printing device is displayed in the printing device, and the menu of the printing device can therefore be generated and displayed so as to be adapted to the user.

### APPLICATION EXAMPLE 5

A server device according to a fifth application example is characterized in comprising a second receiving part for receiving, from an information terminal device connected so as to be capable of communication, user information designed to uniquely identify a user who operates the information terminal device; a third receiving part for receiving, from a printing device connected so as to be capable of communication, printing-device information designed to uniquely identify the printing device; a selectable-service determining part for extracting, based on the printing-device information thus received, services that can be executed by the printing device, and determining, based on the user information thus received, the service that can be selected by the user from the services thus extracted; a generating part for generating, in a format that can be displayed by the printing device, menu information that makes it possible to issue an instruction to execute the service thus determined; and a third transmitting part for transmitting the menu information thus generated to the printing device.

Through such a configuration, the server device receives user information designed to uniquely identify a user who operates the information terminal device, and printing-device information designed to uniquely identify the printing device; extracts, based on the printing-device information thus received, services that can be executed by the printing device; determines, based on the user information thus received, the service that can be selected by the user from the services thus extracted; and generates, in a format that can be displayed by the printing device, menu information that includes the service thus determined. Consequently, a menu that includes the service that can be selected by the user from among the services that correspond to the printing device can be displayed in the printing device, and the menu of the printing device can therefore be generated and displayed so as to be adapted to the user.

### APPLICATION EXAMPLE 6

A server device according to a sixth application example is characterized in that the second receiving part receives, from the information terminal device, first positional information relating to the position of the information terminal device; the third receiving part receives, from the printing device, second positional information relating to the position of the printing device; and the selectable-service determining part determines, based on the first positional information and the second positional information thus received, in addition to the user information, the service that can be selected by the user from the services thus extracted.

Through such a configuration, the service that can be selected by the user from the extracted services can be determined according to the position of the printing device and the information terminal device, in addition to the user information.

### APPLICATION EXAMPLE 7

A server device according to a seventh application example is characterized in having a judgement part for judging, based on a comparison between the first positional information and the second positional information, whether the printing device is usable or unusable by the user.

Through such a configuration, it is possible to judge, based on the positional information about the user and the printing device, whether the printing device is usable or unusable by the user.

### APPLICATION EXAMPLE 8

A server device according to an eighth application example is characterized in having a fourth transmitting part for transmitting, to the information terminal device, printing-device information relating to the printing device judged by the judgement part to be usable; wherein the selectable-service determining part determines the service that can be selected for the printing device corresponding to the printing-device information selected by the information terminal device, from the printing-device information transmitted to the information terminal device.

Through such a configuration, the desired printing device can be selected from printing devices that can be used by the user, and a menu that is adapted to the user can be shown.

### BRIEF DESCRIPTION OF THE DRAWINGS

Referring now to the attached drawings which form a part of this original disclosure:

FIG. 1 is a view showing the functional configuration of the menu display system according to an embodiment of the invention;

FIG. 2 is a view showing an example of the menu screen displayed in the information display part of the printer; and

FIG. 3 is a flowchart showing the process flow of the menu display system according to an embodiment of the invention.

### DETAILED DESCRIPTION OF EXEMPLARY EMBODIMENTS

A menu display system will be described with reference to the drawings.

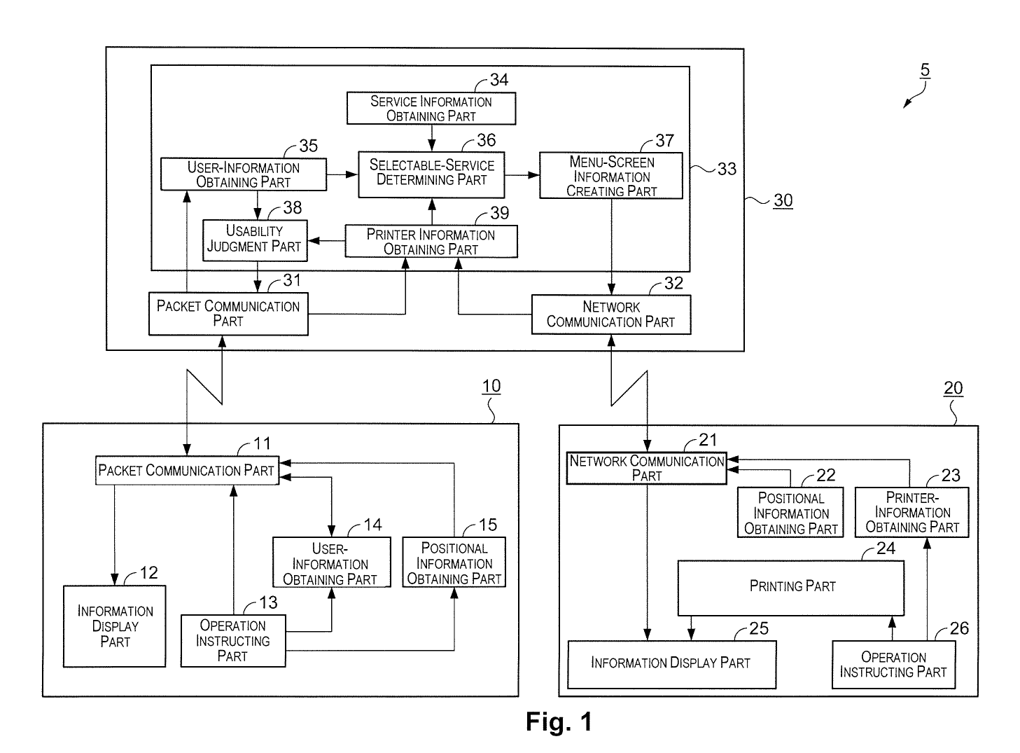

FIG. 1 is a view showing the functional configuration of the menu display system 5 according to an embodiment. The menu display system 5 is composed of a portable terminal 10, which functions as an information terminal device; a printer 20, which functions as a printing device; and a server device (hereafter referred to as a “server”) 30. The portable terminal 10 and the server 30, and the printer 20 and the server 30, are connected so as to be capable of communication. In the menu display system 5, a menu of a service that can be operated by the printer 20 is determined according to the user of the portable terminal 10, and the menu is displayed in the printer 20.

In the present embodiment, the portable terminal 10 and the server 30 are connected via a mobile communication network such as a mobile phone line, and the printer 20 and the server 30 are connected via a wireless local area network (LAN); however, the connection method is not limited to those described above. For example, a configuration is also possible in which a connection is achieved using, e.g., Bluetooth®, WiFi®, or a similar method. The number of printers 20 is also not limited to one, and a configuration may be adopted in which a plurality of printers 20 is connected so as to be capable of communication with the server 30.

Also, each of the portable terminal 10, the printer 20, and the server 30 comprises a central processing unit (CPU), random access memory (RAM), read-only memory (ROM), a memory device, and other devices as hardware (not shown), wherein the hardware operate in coordination with software to achieve a variety of functions described hereinafter. The functions of the portable terminal 10, the printer 20, and the server 30 will next be described.

The function of the printer 20 will first be described. The printer 20 comprises a network communication part 21, a positional information obtaining part 22, a printer-information obtaining part 23, a printing part 24, an information display part 25, and an operation instructing part 26. In the present embodiment, the printer 20 is presumed to be a single-function device. However, this configuration is not limiting; the printer 20 may also be a multifunction device provided with a scanner function or a copying function.

The positional information obtaining part 22 functions as a second positional information obtaining part, and obtains positional information (second positional information) relating to the installation location of the printer 20. In the present embodiment, the printer 20 may house a global positioning system (GPS) device to obtain positional information about the printer 20. Positional information inputted in advance by the user may also be obtained. A position may also be obtained based on positional information about a router or the like of the wireless LAN. The positional information obtained by the positional information obtaining part 22 is transmitted to the server 30 at a predetermined timing.

The printer-information obtaining part 23 functions as a printing-device information obtaining part, and obtains printer information (printing-device information) capable of uniquely identifying the printer 20. In the present embodiment, the printer information is presumed to be printer ID information such as a serial ID, but this configuration is not limiting. The printer information obtained by the printer-information obtaining part 23 is transmitted to the server 30 at a predetermined timing.

In the operation instructing part 26, the user operates an operation button or otherwise issues an instruction to the functional parts of the printer 20 to perform printing or other operation.

The information display part 25 displays menu information for performing operations. The menu information is displayed based on data of a menu screen transmitted from the server 30. The operation instructing part 26 is presumed to be an operation button operated by the user to select a desired service from the menu information.

The network communication part 21 functions as a first receiving part and a second transmitting part, and communicates with the server 30, which is connected via a network such as a wireless LAN. The printing part 24 prints a print image on a paper sheet, based on an operation instruction sent from the operation instructing part 26. In the present embodiment, the printing method is assumed to be an inkjet method, but this configuration is not limiting.

The function of the portable terminal 10 will next be described. The portable terminal 10 is assumed to be a mobile telephone, a smartphone, a portable-type information processing device, or a similar device. The portable terminal 10 comprises a packet communication part 11, an information display part 12, an operation instructing part 13, a user-information obtaining part 14, and a positional information obtaining part 15.

The packet communication part 11 functions as a fourth receiving part and a first transmitting part, and performs packet communication with respect to a communication party (i.e., the server 30) with which a wireless connection has been established via a mobile communication network.

The user-information obtaining part 14 obtains user ID information capable of uniquely identifying a user. In the present embodiment, the user ID information is generated by login verification from the operation instructing part 13 by a user. Consequently, a user ID is presumed to be generated for each single user, but this configuration is not limiting, and a single user ID may also be generated for a group of multiple users.

The positional information obtaining part 15 functions as a first positional information obtaining part, and obtains positional information (first positional information) relating to the installation location of the portable terminal 10. In the present embodiment, the portable terminal 10 may house a GPS device to obtain positional information about the portable terminal 10. A position may also be determined based on information from a base station.

The user ID information obtained by the user-information obtaining part 14, and the positional information obtained by the positional information obtaining part 15 are transmitted to the server 30 together with a transmission request signal when a user operates the operation instructing part 13 to transmit a request for transmission of usable-printer information to the server 30.

The information display part 12 functions as a display part, and displays the information transmitted from the server 30. In the present embodiment, the information display part 12 comprises an email client (i.e., email software) for handling email, or application software for displaying the details of content, and displays information relating to a usable printer 20, transmitted from the server 30.

In the present embodiment, in a case in which usable-printer information is transmitted from the server 30, the information display part 12 displays the received printer information so as to enable selection by the operation instructing part 13, which functions as a selection part. The printer information displayed in the information display part 12 is not limited to one-way transmission from the server 30. For example, a configuration may be adopted in which a two-dimensional barcode attached to or displayed on the printer 20 is read by a user operation of the portable terminal 10, and the corresponding printer information is requested from the server 30 on the basis of the information thus read.

In this case, when the user selects the desired printer 20, information relating to the selected printer 20 is generated and transmitted to the server 30.

The function of the server 30 will next be described. The server 30 comprises a network communication part 32, a menu-generation service part 33, and a packet communication part 31. The menu-generation service part 33 comprises a service information obtaining part 34, a user-information obtaining part 35, a selectable-service determining part 36, a menu-screen information creating part 37, a usability judgment part 38, and a printer information obtaining part 39.

In the present embodiment, the server 30 is configured from a single unit. However, this configuration is not limiting. The server 30 may be configured from a plurality of units, or may have a so-called cloud computing configuration provided with an application programming interface (API) for admitting various service requests. For example, the menu-generation service part 33 may be a service provided by a service server installed by the manufacturer of the printer 20 in order to provide a service to users, and the packet communication part 31 may be a service provided by a base station installed by a telecommunication provider.

The network communication part 32 functions as a third receiving part and a third transmitting part, and exchanges information with the printer 20. The packet communication part 31 functions as a second receiving part and a fourth transmitting part, and exchanges information by packet communication with a communication party (portable terminal 10) wirelessly connected via a mobile communication network.

The printer information obtaining part 39 obtains positional information and printer ID information from the information received from the printer 20 by the network communication part 32. The obtained information is retained so as to be able to be referenced by the selectable-service determining part 36 and the usability judgment part 38. In a case in which the user of the portable terminal 10 selects a printer 20 to be used, information relating to the printer 20 to be used is retained so as to be able to be referenced by the selectable-service determining part 36.

The user-information obtaining part 35 obtains positional information and user ID information from the information received from the portable terminal 10 by the packet communication part 31. The obtained information is retained so as to be able to be referenced by the selectable-service determining part 36 and the usability judgment part 38.

The usability judgment part 38 functions as a judgment part, and judges, based on the information sent from the portable terminal 10 and the printer 20, whether the printer 20 is usable by the user holding the portable terminal 10. In the present embodiment, in a case in which a signal requesting transmission of usable-printer information is transmitted from the portable terminal 10, the usability judgment part 38 makes a judgment on the basis of the user ID information and positional information retained by the user-information obtaining part 35, as well as the positional information and printer ID information retained by the printer information obtaining part 39.

In this case, a judgment is made from the user ID information and the printer ID information as to whether the user has authority to use the printer 20, and when the user has authority, a further decision may be made from the two pieces of positional information as to whether the distance between the user and the printer 20 is within a predetermined range.

In a case in which the usability judgment part 38 judges that the user of the portable terminal 10 can use the printer 20, the server 30 transmits information indicating that the printer 20 can be used to the portable terminal 10.

The service information obtaining part 34 obtains information relating to a predetermined service corresponding to each types of printer 20. The obtained information is retained so as to be able to be referenced by the selectable-service determining part 36. In the present embodiment, the predetermined service is presumed to be a search service, picture data management service, or other service.

The selectable-service determining part 36 determines a selectable service from the service-related information retained by the service information obtaining part 34. The determination is made based on the information retained in the printer information obtaining part 39 and related to the printer 20 used by the user, the positional information about the printer 20, and the positional information and user ID information retained in the user-information obtaining part 35. In the present embodiment, services appropriate for the printer 20 are extracted in accordance with the information relating to the printer 20 from among the services obtained by the service information obtaining part 34, and a selectable service among the extracted services is determined based on the user ID information and the positional information about the printer 20 and the user.

In the present embodiment, the services determined may be graded according to user attributes, frequency of use by the user, and other factors. Information relating to a service may also include information about the language displayed in the information display part 25 of the printer 20, based on the user language or other attribute information. Information relating to the service determined by the selectable-service determining part 36 is sent to the menu-screen information creating part 37.

The menu-screen information creating part 37 functions as a generating part, and creates data (menu information) of a menu screen for instructing execution of the desired service, the menu screen being displayable by the information display part 25 of the printer 20, on the basis of the information relating to the service that is sent from the selectable-service determining part 36. The data of the menu screen created by the menu-screen information creating part 37 are transmitted to the printer 20.

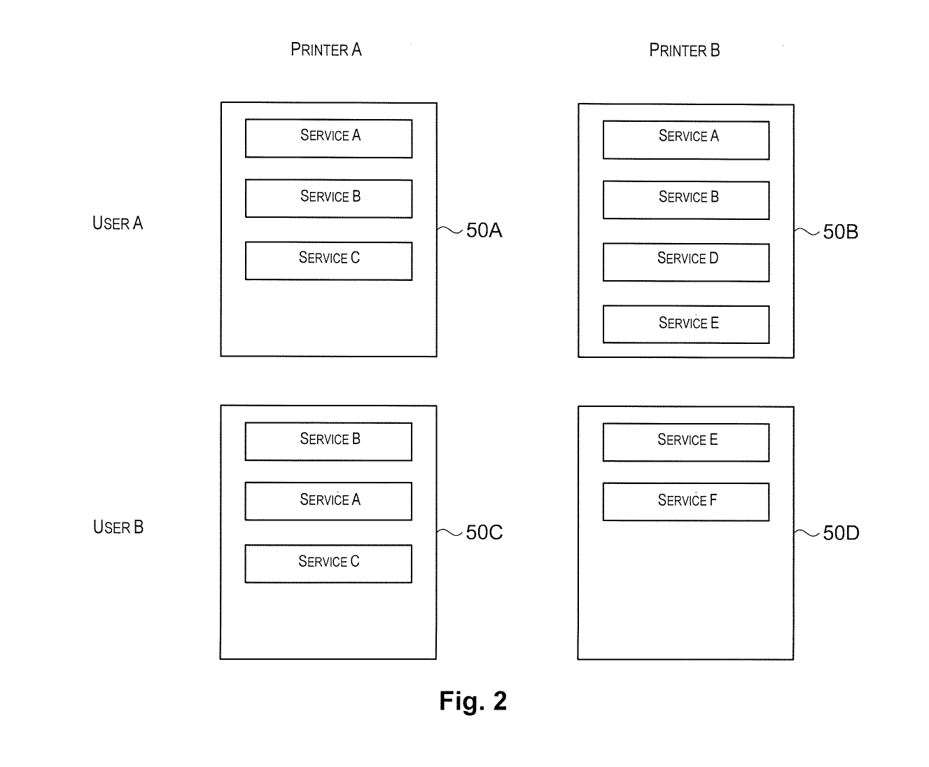

FIG. 2 shows an example of the menu screen displayed in the information display part 25 of the printer 20. For example, service A, service B, and service C are displayed in sequence as selectable services in the menu 50A of printer A when the printer is used by single user A. Service B, service A, and service C are displayed in sequence as selectable services in the menu 50C of printer A when the printer is used by another user B. In this case, since the sequence is determined based on usage frequency and other factors, the sequence in which the services are displayed varies between user A and user B.

Service A, service B, service D, and service E are displayed in sequence as selectable services in the menu 50B of printer B when the printer is used by single user A. Service E and service F are displayed in sequence as selectable services in the menu 50D of printer B when the printer is used by another user B. In this case, depending on the language information, a Japanese menu may be displayed for user A, and an English menu may be displayed for user B. In the present embodiment, the services are presumed to be services performed by cloud computing. A user can log into the corresponding cloud computing service by clicking on the desired service displayed on the menu screen.

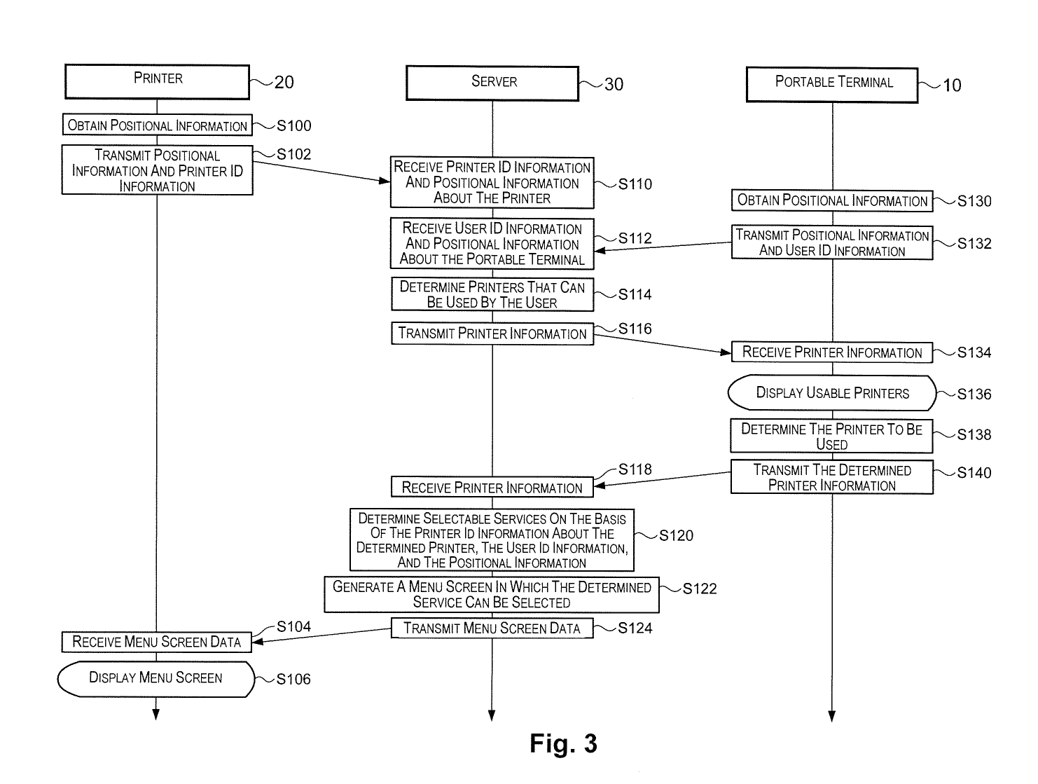

FIG. 3 is a flowchart showing the process flow of the menu display system 5 in the present embodiment. The CPU of the printer 20 first starts up and then obtains the positional information about the printer 20 (step S100).

The CPU of the printer 20 then transmits the positional information and the printer ID information to the server 30 (step S102).

The CPU of the server 30 receives the positional information and printer ID information transmitted from the printer 20 (step S110).

Meanwhile, the CPU of the portable terminal 10 obtains the positional information about the portable terminal 10 at a predetermined timing (step S130).

The CPU of the portable terminal 10 then transmits the obtained positional information and user ID information to the server 30 (step S132).

The CPU of the server 30 receives the positional information and user ID information transmitted from the portable terminal 10 (step S112).

The CPU of the server 30 then determines, based on the information transmitted from the printer 20 and the portable terminal 10, the printer 20 that can be used by the user (step S114), and transmits the printer information relating to the printer 20 thus determined to the portable terminal 10 (step S116).

The CPU of the portable terminal 10 then receives the printer information transmitted from the server 30 (step S134), and displays the usable printer 20 on the basis of the printer information thus received (step S136).

The printer 20 to be used is then determined by the user by being selected from among the displayed printers 20 (step S138), and the CPU of the portable terminal 10 transmits the determined printer information to the server 30 (step S140). The number of printers 20 to be used is not limited to one, and a plurality of printers may be selected.

The CPU of the server 30 then receives the determined printer information (step S118).

The CPU of the server 30 then determines a selectable service on the basis of the printer ID information about the determined printer 20, the user ID information, and the positional information about the printer 20 and the user (step S120).

The CPU of the server 30 then generates a menu screen in which the determined service can be selected (step S122), and transmits the data of the generated menu screen to the printer 20 determined by the user (step S124).

The CPU of the printer 20 then receives the menu screen data transmitted from the server 30 (step S104), generates a menu screen on the basis of the received menu screen data, and displays the menu screen (step S106).

Through the processing described above, a menu corresponding to the position or ID information about the user and the printer is displayed so as to allow selections to be made in the information display part 25 of the printer 20 selected by the user. Consequently, rather than being limited to a menu stored in advance in the printer 20, the menu displayed in the printer 20 can be flexibly changed according to the environment in which the user uses the printer 20, the attributes of the user, and other factors. Since the language of the menu displayed in the printer 20 can also be changed based on information relating to the language used by the user, the printer 20 can easily be adapted to multiple languages by the manufacturer of the printer 20.

The device for performing a procedure such as the one described above may be implemented using a single device or a combination of a plurality of devices, and a variety of types of configurations is included.

What is claimed is:

1. A menu display system in which a server device, a printing device, and an information terminal device are connected so as to be capable of communication, the menu display system comprising:
the information terminal device including
a user-information obtaining part for obtaining user information designed to uniquely identify a user who operates the information terminal device, and
a first transmitting part for transmitting the user information thus obtained to the server device;
the printing device including
a printing-device information obtaining part for obtaining printing-device information designed to uniquely identify the printing device,
a second transmitting part for transmitting the printing-device information thus obtained to the server device,
a first receiving part for receiving, from the server device, menu information for issuing an instruction to execute a predetermined service, and
an information display part for displaying the menu information thus received; and
the server device including
a second receiving part for receiving the user information transmitted from the information terminal device,
a third receiving part for receiving the printing-device information transmitted from the printing device,
a selectable-service determining part for extracting, based on the printing-device information thus received, services that can be executed by the printing device, and determining, based on the user information thus received, the service that can be selected by the user from the services thus extracted,
a generating part for generating the menu information, which includes the service thus determined, and
a third transmitting part for transmitting the menu information thus generated to the printing device.

2. The menu display system according to claim 1, wherein
the information terminal device has a first positional information obtaining part for obtaining first positional information relating to the position of the information terminal device,
the information terminal device transmits the first positional information thus obtained to the server device,
the printing device has a second positional information obtaining part for obtaining second positional information relating to the position of the printing device, and
the printing device transmits the second positional information thus obtained to the server device,
the server device receives the first positional information transmitted from the information terminal device and the second positional information transmitted from the printing device, and
the sever device has a judgement part for judging, based on a comparison between the first positional information and the second positional information thus received, whether the printing device is usable or unusable by the user.

3. The menu display system according to claim 2, wherein
the server device has a fourth transmitting part for transmitting, to the information terminal device, the printing-device information relating to the printing device judged by the judgement part to be usable,
the information terminal device has
a fourth receiving part for receiving the printing-device information transmitted from the server device,
a display part for displaying the printing-device information thus received, and
a selecting part for selecting at least one piece of information from the printing-device information thus displayed, and
the information terminal device transmits the printing-device information selected by the selecting part to the server device, and the server device determines the service that can be selected for the printing device corresponding to the printing-device information transmitted from the information terminal device.

4. A menu display method comprising
connecting a server device, a printing device, and an information terminal device, and
displaying a menu on the printing device so as to be capable of communication,
the printing device obtaining printing-device information designed to uniquely identify the printing device;
the printing device transmitting the printing-device information thus obtained to the server device;
the server device receiving the printing-device information transmitted from the printing device;
the information terminal device obtaining user information designed to uniquely identify a user who operates the information terminal device;
the information terminal device transmitting the user information thus obtained to the server device;
the server device receiving the user information transmitted from the information terminal device;
the server device extracting, based on the printing-device information thus received, services that can be executed by the printing device;
the server device determining, based on the user information thus received, the service that can be selected by the user from the services thus extracted;
the server device generating menu information that makes it possible to issue an instruction to execute the service thus determined;
the server device transmitting the menu information thus generated to the printing device;
the printing device receiving, from the server device, the menu information for executing a predetermined service; and
the printing device displaying the menu information thus received.

5. A server device, comprising:
a second receiving part for receiving, from an information terminal device connected so as to be capable of communication, user information designed to uniquely identify a user who operates the information terminal device;
a third receiving part for receiving, from a printing device connected so as to be capable of communication, printing-device information designed to uniquely identify the printing device;
a selectable-service determining part for extracting, based on the printing-device information thus received, services that can be executed by the printing device, and determining, based on the user information thus received, the service that can be selected by the user from the services thus extracted;
a generating part for generating, in a format that can be displayed by the printing device, menu information that makes it possible to issue an instruction to execute the service thus determined; and
a third transmitting part for transmitting the menu information thus generated to the printing device.

6. The server device according to claim 5, wherein
the second receiving part receives, from the information terminal device, first positional information relating to the position of the information terminal device,
the third receiving part receives, from the printing device, second positional information relating to the position of the printing device, and
the selectable-service determining part determines, based on the first positional information and the second positional information thus received, in addition to the user information, the service that can be selected by the user from the services thus extracted.

7. The server device according to claim 6, further comprising
a judgement part for judging, based on a comparison between the first positional information and the second positional information, whether the printing device is usable or unusable by the user.

8. The server device according to claim 7, further comprising
a fourth transmitting part for transmitting, to the information terminal device, printing-device information relating to the printing device judged by the judgement part to be usable,
wherein the selectable-service determining part determines the service that can be selected for the printing device corresponding to the printing-device information selected by the information terminal device, from the printing-device information transmitted to the information terminal device.
